(19) United States
(12) Patent Application Publication
(10) Pub. No.: US 2011/0167012 A1
(43) Pub. Date: Jul. 7, 2011

(54) MACHINE, ARTICLE OF MANUFACTURE, METHOD, AND PRODUCT PRODUCED THEREBY TO CARRY OUT PROCESSING RELATED TO ANALYZING CONTENT

(76) Inventors: Gavin W. Jenkins, Highland Park, IL (US); Gerald L. Jenkins, Highland Park, IL (US)

(21) Appl. No.: 12/983,570

(22) Filed: Jan. 3, 2011

Related U.S. Application Data
(60) Provisional application No. 61/292,115, filed on Jan. 4, 2010.

(51) Int. Cl. G06Q 50/00; G06F 17/30

(52) U.S. Cl. 705/326; 707/769; 707/E17.014

(57) ABSTRACT

A machine, manufacture, process, and product produced thereby, as well as necessary intermediates, which in some cases, pertains to computers and data processing. Illustratively, there can be a computer system adapted to receive at least one first content item, a second content item, and corresponding rules, and to process at least one query based at least in part on the first content item and the second content item and the first content item rule and the second content item rule, and to retrieve at least one result of the query, a storage medium to store the first content item and the second content item and the first content item rule and the second content item rule and the query and the result, and an output device to report the query and the result, wherein every content item ownership person's access to at least one content item is limited by at least one content item rule that is imposed by a person other than such content item ownership person.

### PRIORITY CLAIM

This application claims the benefit of, and incorporates by reference as if completely restated herein, Ser. No. 61/292,115 filed Jan. 4, 2010.

### TECHNICAL FIELD

The technical field is computers and data processing systems.

### SUMMARY

Depending on the implementation, there is apparatus, a method for use and a method for making, and corresponding products produced thereby, as well as data structures, computer-readable media tangibly embodying program instructions, manufactures, and necessary intermediates of the foregoing, relating to analyzing content.

### BRIEF DESCRIPTION OF THE DRAWINGS

FIG. 1 illustrates the computer system of one embodiment of the invention.

FIG. 2 is a partial flowchart of one embodiment of the invention.

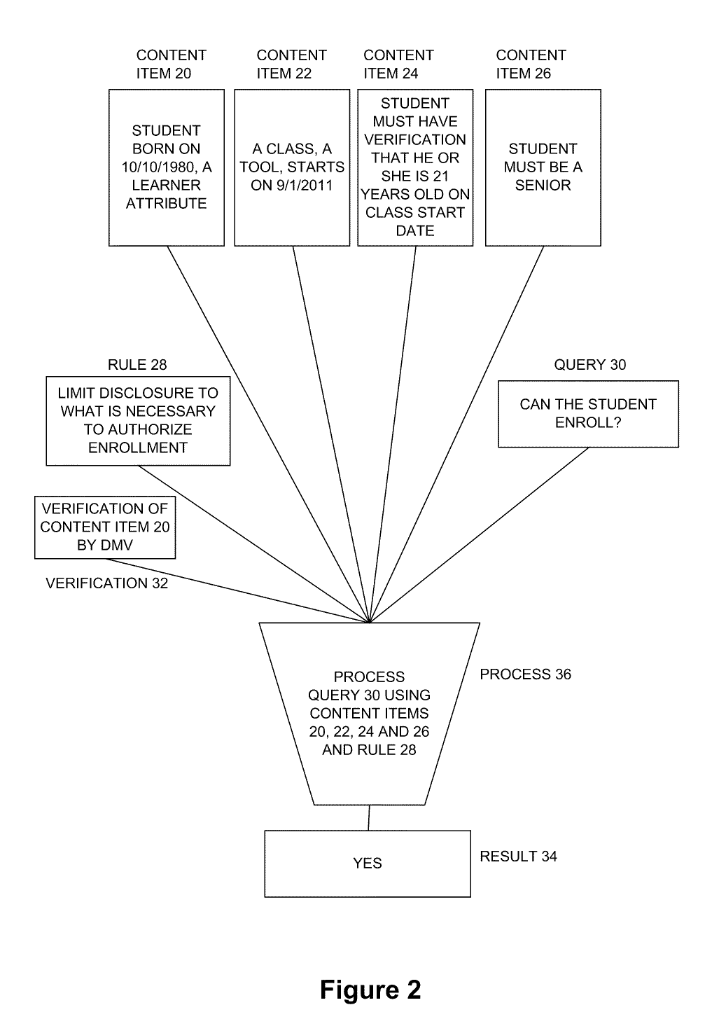

FIG. 2 is a partial flowchart of one embodiment of the invention.

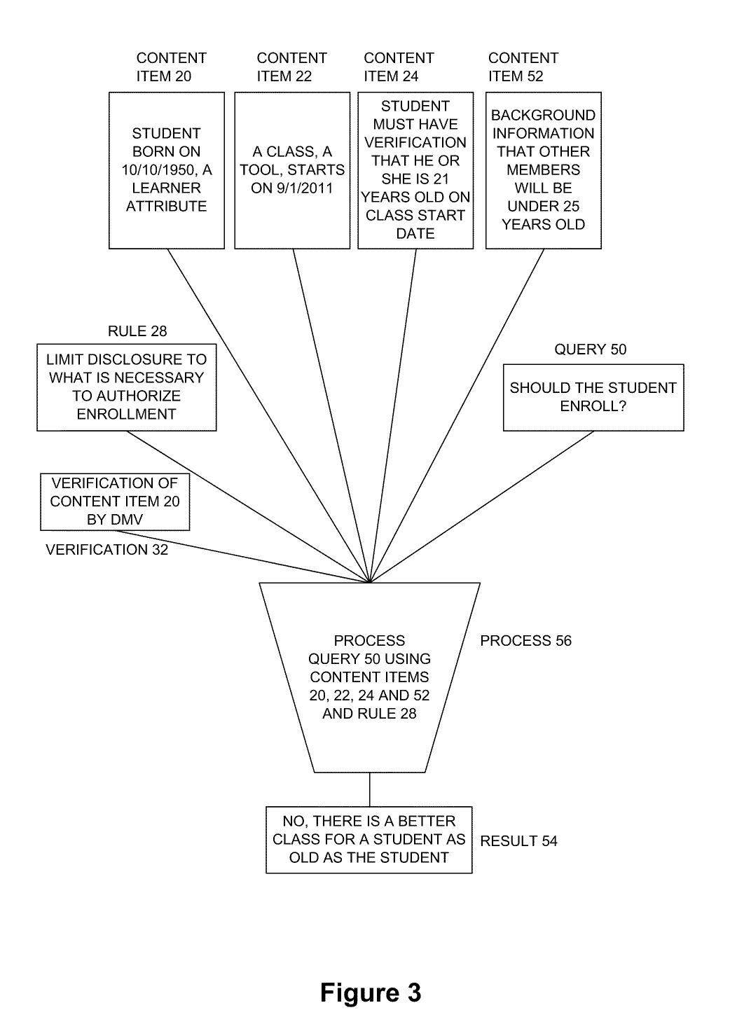

FIG. 4 is a partial flowchart of one embodiment of the invention.

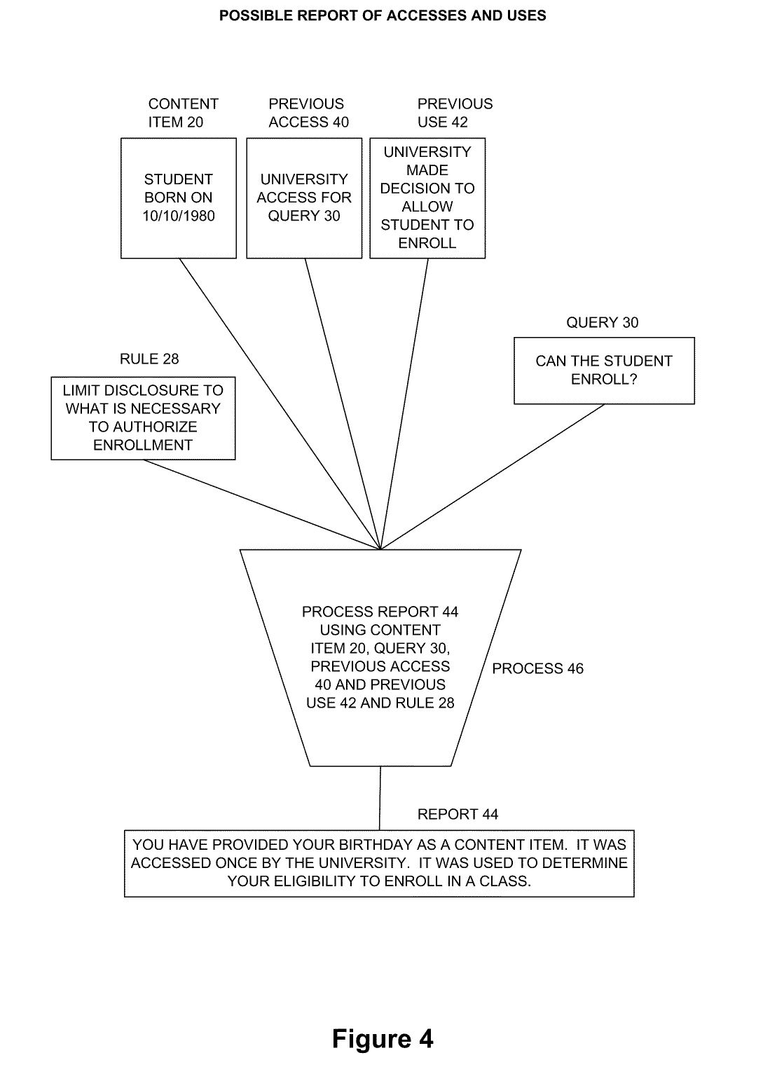

FIG. 5 is a partial flowchart of one embodiment of the invention.

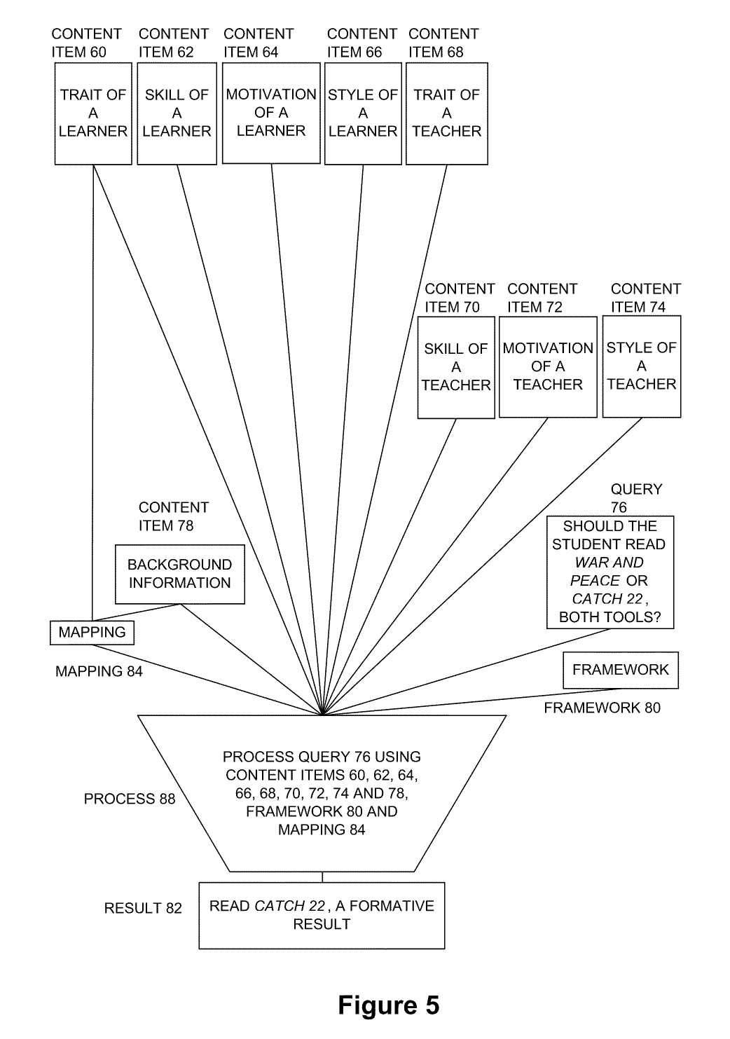

FIG. 6 is a partial flowchart of one embodiment of the invention.

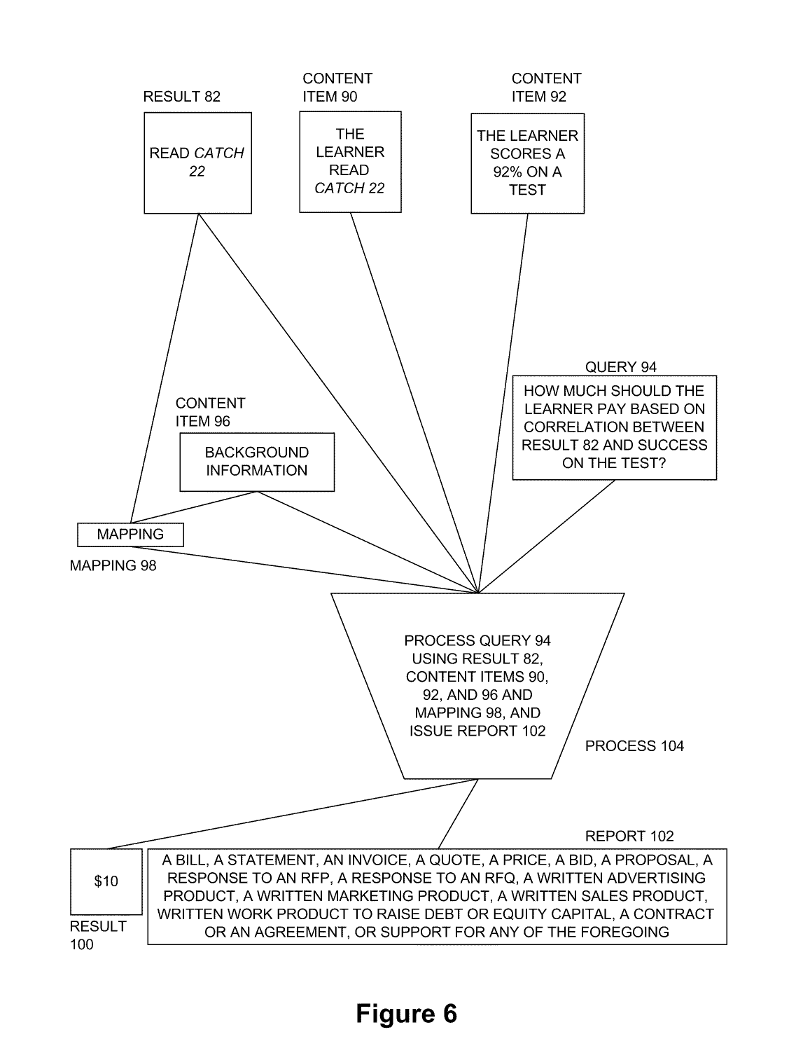

FIG. 7 is a partial flowchart of one embodiment of the invention.

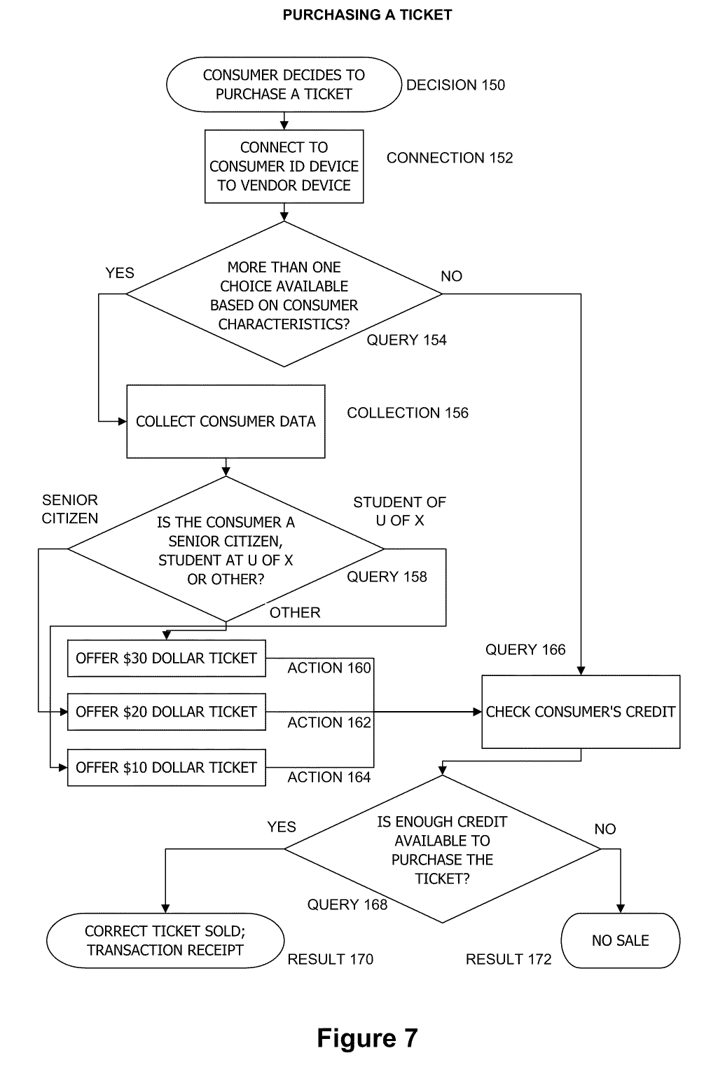

FIG. 8 is a partial flowchart of one embodiment of the invention.

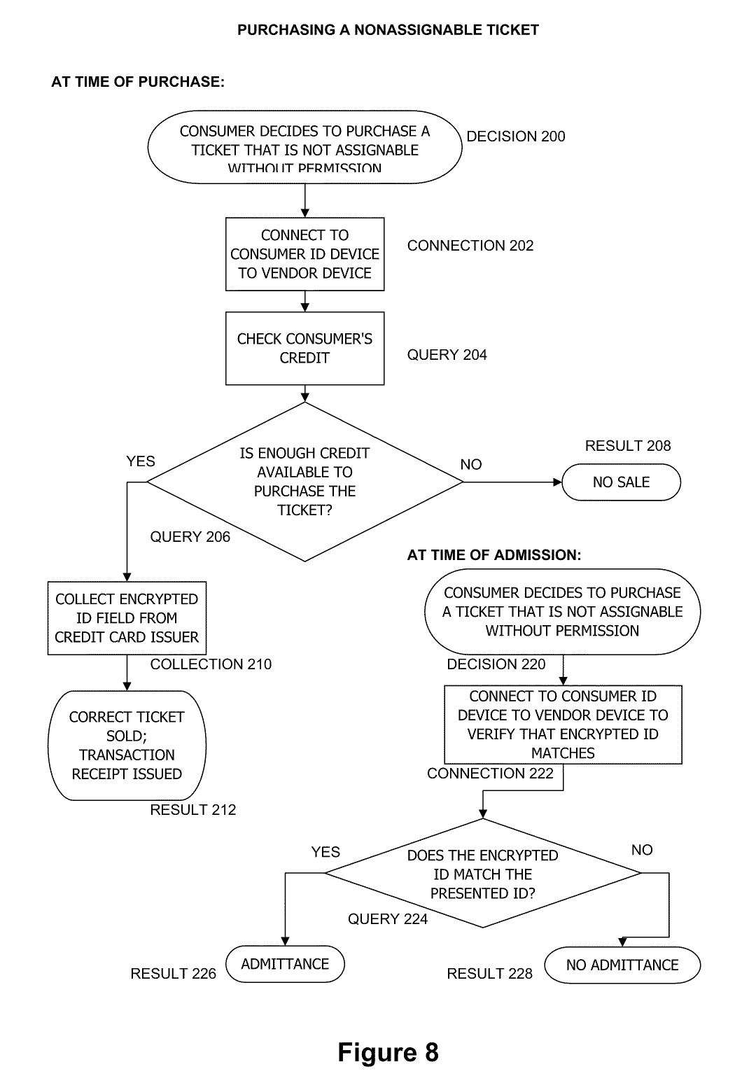

### MODES

As used herein, the term “computer” generally refers to hardware or hardware in combination with one or more program(s), such as can be implemented in software, hardware, or a combination thereof. Computer aspects can be implemented on general purpose computers or specialized devices, including cell phones, tablets and smart cards, and can operate electrically, optically, or in any other fashion. A computer as used herein can be viewed as at least one computer having all functionality or as multiple computers with functionality separated to collectively cooperate to bring about the functionality. Collectively cooperation does not necessarily require constant connection. Logic flow can represent signal processing, such as digital data processing, communication, or as evident from the context hereinafter. Logic flow or “logic means” can be implemented in discrete circuits, analog circuits, programmed computer, or the equivalent. Computer-readable media, as used herein, can comprise at least one of a tape, a written document (including a “mark-sense” card or an XML document), a RAM, a ROM, a disk, a flash drive, an ASIC, and a PROM. Data entry, as used herein, can comprise at least one of (i) manual entry by at least one of one or more keyboards, one or more mice, one or more pens, one or more tablets, one or more scanners, one or more voices, one or more movements or contractions of a body part, one or more body-generated magnetic or electrical signals, or one or more other manual data entry devices, or (ii) electronic entry through one or more physical or wired attachments to computer-readable media or one or more wireless connections to computer-readable media, and in each such cases either directly to the entry device or media or indirectly through a LAN or WAN (including the Internet).

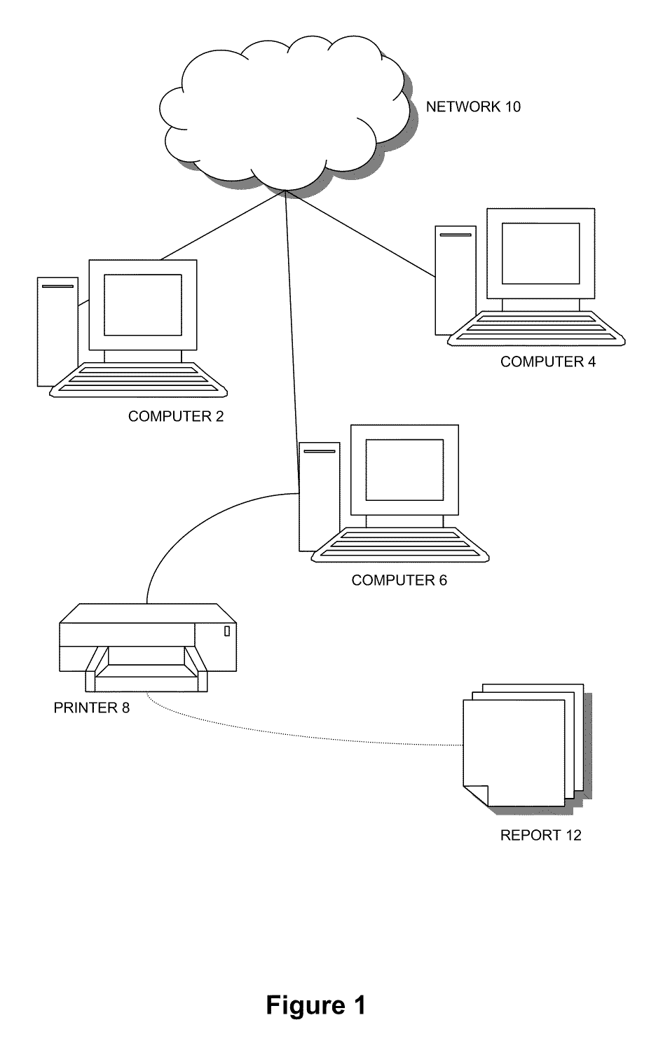

In some embodiments, the computer system will accept data entry and input from multiple computers and multiple persons (computers 2, 4 and 6 shown on FIG. 1). The data can be entered by the person to whom the data being entered relates (the data subject) or by others. For example, an individual might enter his or her own name, age, gender and social security number. The data can also be entered by another person who has a relationship with the data subject. For example, a teacher might enter a student's name and grade for a university course, or an employer might enter an employee's performance review, or a physician might enter a patient's pulse and blood pressure. The data can also be entered by a governmental entity. For example, the Illinois Department of Motor Vehicles might enter a driver's name, driver's license number and date of birth. Each data entry can take a number of forms. It can, for example, be typed in from a keyboard, read in using voice recognition software, or loaded in from a data storage device (like a USB drive or a CD-ROM) or received over a local area network or a wide area network (including the internet) (network 10 on FIG. 1). The data can be entered from multiple computers and stored in multiple locations. The multiple computers can be connected, either constantly, or from time to time.

The data entered can include at least one identity of, at least one personal attribute of, and at least one item of other information about at least one person and at least one identity of, at least one characteristic of, and at least one item of other information about at least one item, including a tool. The data entered can also included generalized data and information, including background information. For example, in some embodiments, in order to suggest a university class to a potential student, the computer system may need data about the location of the student's residence, the venue of the suggested class, the start and ending times of the suggested class, the availability of public transportation, the cost of public transportation, safety concerns of others about public transportation, stations locations, and a schedule of departure and arrival times. The data entered can also generalized information, including background information. For example, when suggesting classes the computer system can take the tendency of many college students to stay up late at night and their unwillingness to get up early in the morning.

In some embodiments, the data entered can include data or information that the person entering the data or the data subject would rather not be available to the general public, an employer, a friend or a family. The types of data about which a person might concern could range from irritation about others knowing too much about daily routines to a deep concern about divulging deeply private information that could harm the data subject or put the enterer of the data into legal jeopardy. For example, many employees would not be comfortable letting their employers see their monthly credit card statement, and some states now prohibit employers from demanding access to prospective employees' credit reports when making hiring decisions. As another example, a student may not want his or her parents to know what last semester's grades were or what his or her credit card statement looks like. In some circumstances, a person may willingly enter data to acquire useful information but may not want to make that same data available to another person. For example, at 10:00 a.m., a student may want to enter his or her geographical location in order to find the nearest coffee shop that serves lattes, but may not want the instructor of his or her 9:30 a.m. university class to know that he or she is not sick in bed.

In some embodiments, the computer system will allow persons to impose rules on access to and use of data. For example, a rule may limit use of data to the primary purpose for which it was originally given or entered (often called primary use), and prevent use of the same data for any other use (often called secondary uses). For example, a student entering his or her geographical location (e.g., either from a dial pad on his or her cell phone or from an automatic transmission from his or her cell phone) may impose a rule that allows MapQuest or Google to run a search for nearby coffee shops but that prohibits all other uses. In addition, the student may want to limit the information that goes to MapQuest or Google to what is essential to the task at hand (sometimes called “need to know” or “minimum necessary information”). For example, his or her geographical locations is essential to the task, but his or her identity, gender, age and status as a student is not. In some embodiments, once the task for which the data was entered is completed (e.g., the cell phone displays the list of nearly coffee shops), the student may require that the computer system, as well as any person to whom the computer system delivered the entered data (as well as any other data relating to the student delivered along with the entered data), immediately flush all such data, including date, time, location and the desire to have a cup of coffee. In some embodiments, however, the service that the student wants to access (provision of a list of nearby coffee shops) may only be available if the student is willing to pay something for it or is willing to allow some secondary uses of all or a portion of the data he or she provided. For example, if the list provider wants to charge the student for the list, it will want sufficient information about the student and the request for the list to bill and collect the amount due and will want the ability to keep that information until any dispute period has expired. If the list provider wants be paid by the nearby coffee shops, the list provider may not need as much data from the student, but it may want to keep a total count of all requests that it received during a time period (often called aggregated data), the nature of each request and where each coffee's name appeared on each list in order to bill the owners of the coffee shops and will want the ability to keep that information until any dispute period with any of the coffee shops have expired. In some embodiments, it is also possible that parties other than the list provider will want access to the data and the ability to engage in secondary uses. For example, the data system itself can be improved if the data system keeps track of the frequency of list requests and their content. The owners of the data system could learn that requests for coffee shops are down and requests for morning workout locations are up and with that information encourage list providers to put more emphasis on finding workout locations and less emphasis on finding coffee shop locations. As another example, the student may be a fugitive from justice, and the police may have a valid warrant for any list requests from the student's cell phone. In that case, the data relating to the request may be given to the police and may be retained until all legal proceedings have been completed.

In some embodiments, because access to and use of each data item will be subject to rules imposed by data providers, data subjects, the computer system itself, law enforcement agencies, the possible number of rules applicable to a large and robust data store can be quite large. Because the rules are machine-readable, the computer can process such a large number of rules before an access is made to the data itself. For example, if a person is highly motivated not to divulge any more data about himself or herself than it is necessary, his unwillingness to divulge may apply to the fact that he or she is highly motivated not to divulge. In that circumstance, he or she may consider that the number of rules that he or she is imposed is itself a data item that cannot be disclosed, not when it is tied to her identity, not when it is done pseudonymously, not when it is done anonymously, and not when it is done in the aggregate with the data from others (e.g., “There are 213 individuals in Illinois who have imposed more than 500 rules.”). After processing the relevant rules, the computer system will determine whether it can access a data item in accordance with the rules and if the computer system can, the computer system will then determine the proper uses to which each data item can be put.

In some embodiments, the computer system can be used to enhance the privacy of an individual. For example, for most of the previous century, a middle-aged patron of a bar could enter the bar and purchase and consume a drink without disclosing his or her identity or any other information about himself or herself to anyone. More recently, depending on the severity of a state's ID laws, a patron may now be required to show someone a government issued ID (usually a driver's license). Although different bars use different systems to view the ID (e.g., an individual briefly views the ID, a machine scans the ID), in some circumstances, the bar electronically scans the ID and retains data about the identity of the patron and additional contact information. In some cases, the identity of the patron and additional contact information is put to a secondary use (e.g., the patron receives a letter informing him that the same band that played the last time he was at the bar is playing again next week). In some embodiments, the computer system will allow data to be entered into a handheld device (e.g., a cell phone, or a smart card), including rules about how that data can be accessed and used. One feature of the device would be a method of confirming that the device belongs to the patron (e.g., a photograph of the patron permanently etched on its surface, or a biometric reader that can read a voiceprint, a typing cadence, an iris, a fingerprint, a face, a retina or a signature). Another feature would be the ability to accept a query, such as “On this day, is the person identified by this device 21 years of age or older?” Another feature would be the ability to say “Yes” or “No.” In these embodiments, no additional information would be made available to anyone at the bar. In addition, no one other than the person holding the device and the person making the query would know that a query had been made.

As another example, if it assumed that other limitations apply to the ability of a bar to serve a particular patron, the query could be changed. For example, if a bar is located on a university campus and, as a condition of its lease, the bar has agreed not to serve freshmen on Monday through Thursday evenings after 10:00 p.m. or on Wednesday evenings the bar is only open to members of the university community, the query could be changed to “On this date and at this time, is the person identified by this device allowed to be served by Joe's Bar?” Again, the only answer would be “Yes” or “No.” Again, only the minimum amount of information will have been divulged to the person checking IDs at the bar (e.g., the person checking would not know the exact reason for the answer). If the patron wants to know why he or she cannot be served, he or she could enter a second query (“Why was I refused service at Joe's Bar?”) and could be told either “Under 21” or “Still a freshman,” or “Not a member of the university community), but none of the answers need be shared with anyone else.

In some embodiments, the person at the bar might be required to confirm that the “Yes” or “No” is being verified by a governmental entity (e.g., the birthday of the patron). This step can be accomplished in a number of ways. For example, the device could divulge enough data to the person at the bar to enable him or her to check though a network (network 10 on FIG. 1) with the governmental entity. The data could be encrypted in a way that would prevent the person at the bar from garnering any additional information about the patron. As another example, the device itself could communicate directly with the governmental entity, receive a data item that the person at the bar could use to confirm government verification. As another example, the device could contain an encrypted verification of a date of birth that when combined with a proper query of a person at a bar would resolve to “Yes” or “No.” In the first of the three cases, the person at the bar would not acquire any unnecessary information about the patron, but the governmental entity would know the identity of the patron, the fact that he or she entered a bar, what bar it was and when he or she entered the bar. In the second of the two cases, the person at the bar would not acquire any unnecessary information about the patron but the governmental entity would know the identity of the patron, the fact that he or she entered a bar, and when he or she entered the bar. In the last of the three cases, neither the person at the bar nor the governmental entity would learn anything about the patron, except that the person at the bar would learn whether the patron was 21 or not.

In other embodiments, it is possible that a university would require a student who is on probation to agree not to attend any bars on campus and to allow the university to enforce the agreement, either by preventing the student on probation from attending campus bars or by asking to be informed each time the student enters a campus bar. In the former case, the query to the device could be “On this date and at this time, is the person identified by this device allowed to be served by Joe's Bar?” The only answer would be a “Yes” or a “No.” Again, only the minimum amount of information will have been divulged to the person checking IDs at the bar (e.g., the person checking would not know the exact reason for the answer). If the student on probation wants to know why he or she cannot be served, he or she could enter a second query (“Why was I refused service at Joe's Bar?”) and could be told either “Under 21” or “Still a freshman,” or “On probation,” but none of the answers need be shared with anyone else. In the latter case, the student on probation would be admitted to the bar, but per the agreement, either the student or the bar would be required to notify the university. Because the person at the bar allowing the student on probation to be admitted to the bar would not normally know that the student is on probation, the student's device could be set to log the query from the person at the bar and to transmit the logged query to the university, either immediately or the next time that the device can communicate with the computer system. Alternatively, the device could send a encrypted message to the person at the bar (readable by the person's device), which message would include information confirming that it came from the device of the student on probation. In its capacity as landlord, the university could ask the bar to send the university copies of all queries and all encrypted device responses and then decrypt the responses. In all cases, except those relating to the students on probation, the decrypted responses would simply inform the university that they contain no additional information. The ones that relate to students on probation would inform the university of the identity of the student, in which case the combination of the bar's query and the unencrypted response would disclose to the university that the student on probation had violated his or her agreement with the university, as the two of them had agreed.

In some embodiments, two parties can each supply information, which each supplying party does not want to share, but from which the other party can craft a useful query result. For example, a educational publisher may create a set of 100 daily lesson plans and 10 accompanying tests to teach 10^{th} grade students World History. It may consider the actual content of those daily lesson plans and all test questions proprietary, but it may want to pilot them with actual 10^{th} graders. It can enter into an agreement with a school district to use the lesson plans and tests for five of its ten World History classes. The agreement could prevent the school district from disclosing the contents of the 100 daily lesson plans or the text of the test questions to others. At the same time, the agreement could also make the certain aggregate test results available to the educational publisher, not only for the 10 supplied tests, but also for a end-of-course test that is prepared by others and is administered to all ten World History classes. The agreement could also cause the educational publisher to make certain aggregate results from a second school district piloting the lesson plans and tests to the school district. In addition, the level of detail relating to test results that is shared between the two school districts can be different than the level of detail that the educational publisher is allowed to see and share with others. For example, the school district may be allowed to query the performance of its students at the question level, as well as the test level. It may be able to map specific question-by-question results to learning objectives and to the end-of-course test, but it will not be given access to the text of the actual test questions. The data to which it has access would enable it to compare student performance for those who used the lesson plans to student performance for those who used other teaching aids. With that data, it can determine whether the lesson plans and tests provided a statistically significant increase in performance. With analogous data from the second school district, it can determine the same the same thing, perhaps comparing the lesson plans and tests against other teaching aids that it had not used. Both determinations could help the school district decide whether the school district should continue using the lesson plans and whether the school district should roll them out district-wide. The second school district could do the same thing, but neither would have access to the other's students' records. In addition, the educational publisher could prevent both school districts from disclosing the comparison information to any other school districts. In addition, the educational publisher could be allowed to run a query to determine whether its product produced a statistically significant benefit when compared to other alternatives, where neither school district gives the educational publisher access to the identity of the teaching aids used in the classes not using the lesson plans and the tests. Both the two school districts and the educational publisher could be allowed by the others to disclose the existence of a statistically significant benefit to anyone.

In some embodiments, the computer can be used to authenticate ticket buyers both at the time of the ticket purchase and at the time of admission to an event. For example, the producer of an event decides that senior citizens pay $10 for a seat, that students of a local college pay $20 for a seat and everyone else pays $30 a seat. At the time of buying a ticket, the ticket buyer, who may or may not be the person who is expected to attend the event, could supply only enough information to (i) convince the producer that the producer will get paid for the ticket and (ii) inform the producer into which of three categories (senior citizen, student of the local college, or anyone else) the expected attendee fits. (i) can be accomplished in a number of ways, including convincing a credit card issuer to promise payment, convincing a bank to promise payment, causing PayPal® to issue payment, supplying a credit application, or identifying himself or herself. In at least some cases, it would not be necessary to give the producer his, her or its identity, nor would it be necessary to give the producer any contact information. Because the ticket price depends only on the category into which the person expected to attend the event fits, there would not necessarily be a requirement to identify the person expected to attend.

Optionally, the ticket buyer might give additional information to the producer (e.g., the person expected to attend is wheelchair bound or is blind) in order to improve the expected attendee's experience at the event. Once the producer receives the necessary information from the ticket buyer, the producer can reserve a seat and issue a ticket, which could, for example, be an encrypted message that can be used to identify the person who is expected to attend as the person who should be admitted to attend. Although the level of security of the message could be a matter of negotiation between the producer and the ticket buyer, the message could be encrypted with the public key of the ticket buyer (to keep the message confidential to the ticket buyer) and the private key of the producer (to authenticate the ticket). Other keys could be used to maintain confidentiality and security as the message is transmitted to from the ticket buyer to the expected attendee. At the time that a ticket holder request admission to the event, the ticket holder could supply the producer with the producer's encrypted message (no longer encrypted by the ticket buyer's or ticket holder's keys) and if the ticket is a $10 ticket, a verified “Yes” answer to the query “Are you a senior citizen?”, and if the ticket is a $20 ticket, a verified “Yes” answer to the query “Are you a student of college XXX?”. Although the query could be answered by means of a communication with a verifier at the time of admission, it could also be verified with an encrypted message supplied by the ticket holder to the producer.

Important fields in a possible Transaction Receipt:

| | Access rights | | | |
|---|---|---|---|---|
| | | | Credit | |
| | | | card | Verifier of |
| Fields | Consumer | Vendor | issuer | consumer |
| The fact that the purchase | X | X | X | |
| took place | | | | |
| Amount of purchase | X | X | X | |
| Description of item or service | X | X | | |
| purchased | | | | |
| Special characteristics of the | X | X | | X |
| consumer that affect the price | | | | |
| or availability of the good or | | | | |
| service | | | | |
| (senior citizen, over 21, not a | | | | |
| convicted felon, student at U | | | | |
| of X) | | | | |
| Identity of the vendor | X | X | X | |
| Identity of the consumer | X | | X | X |
| Identity of the credit card | X | X | X | |
| issuer | | | | |
| Identity of the verifier | X | X | | X |
| Ticket identifier | X | X | | |

In this embodiment, there is no item of data that all parties need to know, and no party other than the ticket buyer needs to know all of the items of data. Assuming the existence of a public key infrastructure in which the consumer, the credit card issuer, the vendor and the verifier all participate, those skilled in the art can encrypt the transaction receipt in a way that each of the four have access to only what it is authorized to see. For example, each of the fields can be replicated four times (once for each of the consumer, the credit card issuer, the vendor and the verifier). In each case in which one of the four is entitled to have access to a field, the data in the field replicated for it can be encrypted with its public key, giving it the ability to decrypt the field with its private key and have access to the data in the field. In each case in which one of the four is not entitled to have access to a field, an agreed symbol (e.g., “NA”) can be appended to random filler data and encrypted with its public key, giving it the ability to decrypt the field with its private key and learning that it does not have access to the data in the field.

In some embodiments, if the producer elects or is required to prevent the person who gains admission from being anyone other than the original expected attendee (or a replacement expected attendee approved by the producer), sufficient information can be supplied to the producer to respond to the query “Are you the person who the ticket buyer expected to attend at the time that the ticket was purchased?” with a “Yes.” Because the producer may not trust a response that is solely within the control of the ticket buyer and the attendee (for example, the ticket buyer could have been a ticket scalper and the attendee could be a person who paid the ticket scalper a price above the original price of the ticket), the producer may require that some level of verification that the identity of the expected attendee has not changed. One approach could be for the producer to require the name of the expected attendee at the time the ticket is purchased and then asking at the time of requested admittance, “Are you Xxxxx Xxxxxxx?” Another approach, which would not require the expected attendee's name to be divulged to the producer, could be as follows:

Important fields in a possible Transaction Receipt:

| | Access rights | | | |
|---|---|---|---|---|
| | | | Credit | |
| | | | card | Verifier of |
| Fields | Consumer | Vendor | issuer | consumer |
| The fact that the purchase | X | X | X | |
| took place | | | | |
| Amount of purchase | X | X | X | |
| Description of item or | X | X | | |
| service purchased | | | | |
| Identifier of person | X | Encrypted | X | X |
| expected to attend | | | | |
| Identity of the vendor | X | NA | X | |
| Identity of the consumer | X | | X | X |
| Identity of the credit card | X | X | X | |
| issuer | | | | |
| Identity of the verifier | X | X | | X |
| Ticket identifier (includes | X | X | | |
| encrypted identifier) | | | | |

In this embodiment, there is no unencrypted item of data that all parties need to know, and no party needs to know all of the items of data. All parties have access to the encrypted identifier, but no one other than its issuer can read it. Assuming the existence of a public key infrastructure in which the consumer, the credit card issuer, the vendor and the verifier all participate, those skilled in the art can encrypt the transaction receipt in a way that each of the four have access to only what it is authorized to see. For example, each of the fields can be replicated four times (once for each of the consumer, the credit card issuer, the vendor and the verifier). With the exception of encrypted identifier, in each case in which one of the four is entitled to have access to a field, the data in the field replicated for it can be encrypted with its public key, giving it the ability to decrypt the field with its private key and have access to the data in the field. In each case in which one of the four is not entitled to have access to a field, an agreed symbol (e.g., “NA”) can be appended to random filler data and encrypted with its public key, giving it the ability to decrypt the field with its private key and learning that it does not have access to the data in the field. With respect to the encrypted identifier, the only information that the producer needs to know is that identity of the person asking for admission is the same person whose identity was used at the time that the ticket was purchased, not necessarily the identity itself.

In some embodiments, at the time of purchase, the credit card issuer can supply a “ticket stamp,” i.e., a transaction receipt that includes the identity of the expected attendee, encrypted in a way that prevents the producer from learning its contents other than to confirm that the name of the actual attendee matches the expected attendee name supplied at the time that the ticket was purchased. For example, at the time of purchase the credit card issuer can hash the combination of the expected attendee's name and a unique confidential string. It can then send a plain text copy of the hash to the producer and a second copy encrypted with the producer's public key to the ticket purchaser by including it in the transaction receipt. At the time of purchase, in response to the query “Are you the same person who was expected to attend at the time that the ticket was purchased?”, the attendee's device can send the encrypted copy of the hash to the producer's device. The producer's device decrypts the hash received from the attendee's device with its private key. If the decrypted hash matches the hash that the producer received at the time of the ticket purchase, the producer can allow the attendee to attend the event.

In some embodiments, three categories of parties (persons who are looking for coffee shops, a company that provides proximity-based searches, and coffee shops) can use a common database. Each person looking for a nearby coffee shop can agree to pay 5¢ for a coffee shop search. The search company agrees to provide the search for 5¢, as well as a payment from each coffee shop that appears on the list (e.g., 3¢ from the coffee shop number one on the list, 2¢ from the coffee shop number two on the list, and 1¢ from the coffee shop number three on the list, provided that the search company receives double those amounts from the coffee shops for searches between 6:00 a.m. and 9:00 a.m.), and provided further that it receives an additional 5% of the purchase price if the person looking makes a purchase online in connection with the search. The person looking requests a search and orders a latte online from the second ranked coffee shop, expecting to pick it up in ten minutes. The computer system establishes a record for the search that includes fields for the identity of the person looking, the amount paid by the person looking, the identity of the search company, the identity of each of the three coffee shops, the amount to be paid by each coffee shop (based on rank), a unique number for the search, the search ranking of each of the three coffee shops in the search, the identity of the coffee shop that sells an item, and the price of the item. The search company promises that the search company will not disclose the identity of the person looking to any of the three coffee shops (unless the person looking purchases something from a coffee shop online and then only if he fails to arrive at the coffee shop and pay for what he ordered online within thirty minutes of the online order). Each coffee shop is promised that neither the person looking nor any other coffee shop will be told what it pays to be included in searches or what it pays if something is purchased online and that no one other than the person looking will be told what he orders, including the search company. A sample subset of a transaction record follows:

Important fields in a possible Transaction Record:

| | Access rights | | |
|---|---|---|---|
| | Person | Search | Coffee |
| Fields | looking | company | shops |
| The fact that a search was made | X | X | X |
| The date and time of the search | X | X | X |
| (for coffee shops only whether | | | |
| the search in the 6:00 a.m. time | | | |
| to 9:00 a.m. time slot or not) | | | |
| The identity of the person looking | X | X | |
| The amount paid by the person | X | X | |
| looking for the search | | | |
| The identity of each the three | X | X | Only its own |
| coffee shops | | | |
| The amount that each coffee shop | | X | Only what it |
| pays for a number one ranking | | | pays itself |
| The amount that each coffee shop | | X | Only what it |
| pays for a number two ranking | | | pays itself |
| The amount that each coffee shop | | X | Only what it |
| pays for a number three ranking | | | pays itself |
| The item purchased | X | | Only the |
| | | | one selling |
| An order number for the item | X | | Only the |
| purchased | | | one selling |
| The price of the item purchased | X | X | Only the |
| | | | one selling |
| The percentage payable to the search | | X | Only the |
| company based on online sales | | | one selling |

In this embodiment, there are only a few item of data that all parties need to know, and no party needs to know all of the items of data. Assuming the existence of a public key infrastructure in which the search company and all three coffee shops participate, those skilled in the art can encrypt the transaction receipt in a way that each of the person looking, the search company and the three coffee shops have access to only what it is authorized to see. For example, each of the fields can be replicated five times (once for each of the person looking, the search company, and each of the three coffee shops). In each case in which one of the five is entitled to have access to a field, the data in the field replicated for it can be encrypted with its public key, giving it the ability to decrypt the field with its private key and have access to the data in the field. In each case in which one of the five is not entitled to have access to a field, an agreed symbol (e.g., “NA”) can be appended to random filler data and encrypted with its public key, giving it the ability to decrypt the field with its private key and learn that it does not have access to the data in the field. It is also possible to modify a field for a particular party in order to minimize the data to which it has access. For example, in order to compute the amount due to the search company, the coffee shop does not need to know the exact time of the search. It only needs to know whether it took place in the 6:00 a.m. to 9:00 a.m. time slot or not. The time field devoted to the coffee shops can be altered to become a binary “True”/“False” field (True if the search takes place in the 6:00 a.m. to 9:00 a.m. time slot, False if not). In another embodiment, all database queries initiated by a coffee shop relating to search times could be limited to queries that ask for result sets for which the time field is False if the time field in the database is either less then 6 or more than 9 (assuming a 24 hour clock) and True if the time field in the database is both (6 or more) and (9 or less) (again assuming a 24 hour clock).

In some embodiments, the computer system has a capability of one or more of, and a computer-implemented method or process is comprised of, receiving, storing, retrieving, analyzing and reporting at least one of one or more identities of learners, teachers and other interested parties; one or more traits of learners, teachers and other interested parties; one or more characteristics of learners, teachers and other interested parties; one or more statuses of learners, teachers and other interested parties; one or more skills of learners, teachers and other interested parties; one or more motivations of learners, teachers and other interested parties; one or more styles of learners, teachers and other interested parties; one or more histories of learners, teachers and other interested parties; one or more records and learners, teachers or other interested parties, one or more activities of learners, teachers and other interested parties; one or more methods of learners, teachers and other interested parties; one or more methodologies of learners, teachers and other interested parties; one or more written work products of learners, teachers and other interested parties; one or more tools; one or more items of background knowledge; one or more written work products (in hard copy or electronic form); and one or more mappings between or among any of the foregoing, and any interrelationships between or among any of the foregoing.

A person is an individual or entity. Learners and teachers are persons. Other interested persons are persons who have an interest in a learner or a teacher. Other interested persons can include the friends (past, current and future), families, teachers (past, current and future), students (past, current and future), co-workers (past, current and future), co-students, co-teachers, contracting parties (past, current and future), and other interested parties (past, current and future) of one or more of them

A data subject is at least one of the persons to whom a content item relates.

A rule is a machine-readable requirement or prohibition that limits that nature and scope of a query or that limits the use to which the result of a query can be put. An example of a rule is a requirement that a record that includes fields that contain the name of an individual's disease and the zip code of the individual's primary residence should be ignored if the total number of records whose disease name and zip code fields match those of the individual is less than five. Another example of a rule is a prohibition against showing a result that includes an individual's financial data to a prospective employer of the individual.

A personal attribute of a learner, teacher or interested person includes a trait, characteristic, status, skill, motivation, style, history, record, performance result, activity, method, methodology, or written work product of the learner, the teacher or the interested person

A tool includes any item that is designed or used to accomplish or facilitate an act of acquiring, learning, teaching or imparting knowledge, data, information or skills.

A tool attribute of a tool includes a trait, characteristic, status, history, record, or performance result of the tool. A tool attribute can also include at least one description, at least one item of content, at least one metric or rubric, at least one objective, at least one ability to acquire, learn, teach or impart knowledge, data, information, and skills, at least one requirement, at least one technique the tool uses, at least one or more prerequisite, at least one other tool on which the tool depends, and at least one tools for which the tool prepares.

A query can include a mathematical computation, data sorting; data rearranging; data reorganizing; data manipulation; data mining; at least one SQL search; data warehousing; data “slicing and dicing”; dynamic system modeling, emulation and implementation; a simulation of teaching and learning activities; dynamic field (including one or more dynamic neural fields) modeling, emulation and implementation; Bayesian logic modeling, emulation and implementation; Bayesian statistical modeling, emulation and implementation; curve fitting; neural net and connectionist modeling; fuzzy-neural system emulation and implementation; classical logic and fuzzy logic techniques; at least one regression (e.g., linear, multilinear and nonlinear); at least one other statistical analysis or inference, and at least one other heuristic method or approach. A query can include or use at least one mapping or at least one interrelationship among two or more of one or more learners, teachers and interested persons; their individual and collective traits, characteristics, statuses, skills, motivations, styles, histories, records, performance results, activities, methods, methodologies, or written work products; at least one tool; at least one of the tool's traits, characteristics, and performance results; and background information.

A result can include a weighing, a distortion, a ranking, a rating, a prioritization, a mapping, an interrelation and a comparison among learner(s), teacher(s) and tool(s), and making at least one comparison, at least one determination or at least one selection based on the weighing, distortion, ranking, rating, prioritization, mapping, interrelation or comparison based on one or more factors. A result can also include a formulation of one or more tests, one or more test questions, one or more study aids, one or more tools, one or more teaching aids, or support for any of the foregoing.

A framework can include a structure, standard, protocol, framework or taxonomy.

A price can be computed on a per learner basis, a per teacher basis, a per enterprise basis, a per machine basis, a per concurrent user basis (whether learner or teacher), a per seat basis, a per use basis (possibly with pricing based on the nature of each use), or a flat fee basis

A performance requirement can be meeting an agreed goal or target or meeting a goal or target imposed by law, regulation or governmental rule. The goal, target or government rules can be relative or absolute and can be based on a learner, a teacher, an interested party, or a tool.

A verifier is a person who verifies, vouches for, confirms, or attests to content, including the identity of a person. A verifier could, for example, be the State of Illinois or the U.S. federal government.

A content item is a machine-readable item of data or information, but excluding passwords or other forms or authentication. A content item is machine readable

The identity of a learner, a teacher or an other interested party includes data and information that can be used to distinguish the learner, the teacher or the other interested party from other persons and can include one or more names, one or more addresses, one or more ID numbers, one or more items of contact information, one or more physical attributes, one or more pieces of information known by the learner, the teacher or the other interested party (e.g., a password), one or more items of pseudonymous information, one or more items of pseudonymous information anonymous information, and any other identifying information.

A trait of a learner, a teacher or an other interested party includes a feature that helps describe the learner, the teacher or the other interested party and can include at least one feature relating to the capacity to acquire, learn, teach or impart one or more skills, at least one feature relating the aptitude to acquire, learn, teach or impart in one or more ways, at least one feature relating to the ability to acquire, learn, teach or impart in one more ways, at least one feature relating to one or more forms of intelligence, at least one feature relating to one or more views, at least one feature relating one or more attitudes, at least one feature relating to one or more assumptions, at least one feature relating to one or more habits, at least one feature relating to one or more biases, and at least one feature relating to one or more prejudices.

A characteristic of a learner, a teacher or an other interested party includes an attribute that helps describe the learner, the teacher or the other interested party and can include at least one of one or more personality types, one or more qualifications, one or more inclinations, one or mannerisms, one or more cultural backgrounds, one or more ethnic backgrounds, one or more religious backgrounds, one or more behaviors, one or more temperaments, one or more tendencies, and one or more knowledge levels.

A status of a learner, a teacher or an other interested party includes a current position, state, or condition of the learner, the teacher or the other interested party and can include at least one of one or more feelings, one or more health statuses, one or more emotions (e.g., distracted, afraid, angry), one or more moods, and one or more circumstances of an individual (e.g., tired, hungry, cold, hot, scared), one or more circumstances of the local environment (e.g., cold, hot, dangerous, noisy, dirty, rundown), and one or more levels of knowledge (e.g., awareness or mastery of at least one learning objective).

A skill of a learner, a teacher or an other interested party includes an ability or capacity than can be acquired by the learner, the teacher or the other interested party through learning, teaching, training or practicing and can include at least one of one or more capabilities, one or more disabilities, one or more strengths, one or more weaknesses, one or more talents, one or more expertises, one or more specialties, one or more competencies, one or more items of know how, one or more limitations, one or more assets, and one or more liabilities.

A motivation of a learner, a teacher or an other interested party includes anything that arouses, convinces or encourages the learner, the teacher or the other interested party to do something or to refrain from doing something and can include at least one of one or more preferences, one or more interests, one or more desires, one or more wants, one or more wishes, one or more stimuli, one or more reasons, one or more purposes, one or more impulses, one or more inducements, one or more motives, and one or more incentives

A style of a learner, a teacher or an other interested party includes the manner in which or how learning or teaching is done, is accomplished or happens in relation to the learner, the teacher or the other interested party and can include at least one of one or more methods, one or more modes, one or more techniques, one or more approaches, one or more ways, one or more behaviors, and in particular one or more of a bodily-kinesthetic, musical, interpersonal, intrapersonal, aural/visual-spatial, logical-mathematical, verbal-linguistic or other known learning or teaching style, or any combination thereof.

A history of a learner, a teacher or an other interested party includes one or more past events relating to the learner, the teacher or the other interested party and can include at least one of one or more activities, one or more traditions (including family or cultural traditions), one or more experiences, one or more accomplishments (e.g., personal, educational, professional), one or more resumes or CVs, one or more syllabuses prepared or used, one or more lessons plans prepared or used, one or more records (whether embodied in hard copy or in electronic form), and one or more performance results (however recorded or retained or summarized or reviewed or described).

A record of a learner, a teacher or an other interested party includes anything that provides evidence of, documentation of or information about prior events or circumstances relating to the learner, the teacher or the other interested party and can include at least one of data or information contained in a student or employee information system, one or more attendance records, one or more tardiness records, one or more disciplinary records, one or more course completion records, one or more degrees and diplomas given or received, one or more records of interactions with others, one or more credentials, one or more evaluations, one or more portfolios, one or more journals, one or more diaries, one or more memoirs, one or more observations, one or more accounts, one or more explanations, one or more opinions, one or more reviews, one or more inventories, one or more events attended, one or more recommendations, data and information relating to one or more achievements, data and information relating to one or more successes, data and information relating to one or more failures, data and information relating to one or more skills, data and information relating to one or more abilities to acquire, learn, teach or impart one or more skills, data and information relating to how skills are acquired, learned, taught or imparted or are better or best acquired, learned, taught or imparted, data and information relating to how knowledge and data are acquired, learned, taught or imparted or are better or best acquired, learned, taught or imparted, data and information relating to preferences for acquiring, learning, teaching or imparting knowledge, skills, data or information, data and information relating to how acquiring, learning, teaching or imparting can be motivated or encouraged or can be better or best be motivated or encouraged, and data and information relating to incentives that can be used to motivate, to encourage or to acquire, learn, teach or impart or can be better or best used to motivate, to encourage or to acquire, learn, teach or impart.

A performance result of a learner, a teacher or an other interested party includes an outcome or a result of something that is done by the learner, the teacher or the other interested party and can include at least one of a summary, a description or a recording of one or more conversations, of one or more discussions, of one or more recitations, of one or more oral presentations (including lectures or classroom presentations), of one or more written presentations (whether in hard copy or electronic form), of one or more scholastic performances, of one or more artistic performances or creations, of one or more athletic performances, in all cases whether individually or as a member or part of a group. Performance results can be in the form of at least one of one or more letter grades, one or more numerical grades, one or more scores, one or more tallies or tabulations of correct or incorrect responses, one or more narratives or evaluations about one or more performances (by the performer or by another), one or more analyses of one or more compliances or noncompliances with rubrics or metrics, one or more tabulations of one or more completed or non-completed homework assignments (optionally including any results thereof), and one or more comparisons to one or more standards (e.g., absolute, relative, growth, acceleration).

An activity of a learner, a teacher or an other interested party includes an action that is undertaken by the learner, the teacher or the other interested party or in which the learner or teacher participates or is involved, including reading an item, viewing or watching an item, hearing an item, or participating in something.

A methodology of a learner or a teacher includes a collection of at least one method, practice, procedure or rule and can include at least one of one or more strategies, one or more approaches, one or more plans, one or more systems, one or more patterns of behavior, one or more tactics, and one or more structures.

A tool includes any item that is designed or used to accomplish or facilitate an act of acquiring, learning, teaching or imparting knowledge, data, information or skills and can include at least one of one or more learning objectives, one or more sets of learning objectives, one or more courses, one or more textbooks, one or more study guides, one or more tutoring sessions, one or more learning or teaching aids, one or more other learning tools, one or more lectures, one or more lesson plans, one or more curricula, one or more rubrics or metrics, one or more presentations, one or more outlines, and one or more worksheets. A tool can either be tangible (e.g., a test booklet, a written lesson plan, a math manipulative, a personal digital assistant) or intangible (e.g., an objective, a goal, a framework). A tool can have at least one of the following characteristics or attributes: one or more alignments with, one or mappings to, or one or more relationships with, one or more other tools, one or more learning objectives, one or more curricula, one or more standards, one or more metrics, and one or more rubrics, one or more amounts of effort needed to use the tool (either as a learner or as a teacher), one or more costs of using the tool (either as a learner or as a teacher), one or more segments of time needed to use the tool (either as a learner or as a teacher), one or more structures, one or more learning styles upon which the tool depends, one or more learning styles that the tool supports, one or more assumptions upon which the tool is based, one or more capabilities, one or more promised capabilities, one or more proven capabilities, one or more deficiencies, one or more acknowledged deficiencies, one or more proven deficiencies, one or more prior successes, one or more prior failures, one or more reviews, one or more evaluations (objective, subjective, statistical, anecdotal), one or more stated goals, one or more stated purposes, one or more items with which the tool complies, one or more rubrics or metrics against which the tool is measured, one or more opinions about the tool, one or more observations about the tool, one or more reviews of the one or more opinions of the tool, one or more achievements, one or more reputations, one or more applicabilities, the tool's relevance, one or more summaries, one or more validities, one or more manners in which the tool learns, teaches or imparts knowledge, data, information, or skills, and one or more accomplishments. A tool can have at least one of the following components: one or more descriptions, content, one or more metrics or rubrics, one or more objectives, one or more abilities to acquire, learn, teach or impart knowledge, data, information, and skills, one or more requirements, one or more techniques the tool uses, one or more prerequisites, one or more other tools on which the tool depends, and one or more other tools for which the tool prepares.

In some embodiments, the computer system has the capability of receiving knowledge, data or information about other factors affecting one or more relationships of learners, teachers and tools, including at least one of a number of participants, proximity of learner(s) and teacher(s), time available, and resources available

The computer system, in some embodiments, has a capability of one or more of receiving data entry, storing data, retrieving data, analyzing and reporting of (i) at least one of one or more identities of learners, teachers and other interested parties, one or more traits of learners, teachers and other interested parties, one or more characteristics of learners, teachers and other interested parties, one or more statuses of learners, teachers and other interested parties, one or more skills of learners, teachers and other interested parties, one or more motivations of learners, teachers and other interested parties, one or more styles of learners, teachers and other interested parties, one or more histories of learners, teachers and other interested parties, one or more records and learners, teachers or other interested parties, one or more activities of learners, teachers and other interested parties, one or more methods of learners, teachers and other interested parties, one or more methodologies of learners, teachers and other interested parties, one or more mappings, one or more relationships, one or more tools, and one or more items of background knowledge, including the interrelationships of any or all of the foregoing, (ii) one or more mappings of any of the items listed in (i) above (either alone or in combination with other items listed in (i) above) to any other of the items listed in (i) above (either alone or in combination with other items listed in (i) above), and (iii) written work product that incorporates any of the items described in (i) and/or (ii) above. Data can be input into a computer system, including at least one computer, at least one central processing unit and memory, relating to at least one aspect of at least one of the foregoing identities, traits, characteristics, statuses, skills, motivations, styles, histories, records, activities, methods, methodologies, tools, mappings, and background knowledge. Data may be input by at least one learner, one teacher or one other interested person, or any combination thereof.

In some embodiments, the computer system has a capability of receiving data relating to background knowledge. An item of background knowledge includes knowledge, data or information related to learning, teaching, acquiring knowledge, data, information or skills, and imparting knowledge, data, information or skills and can include national performance standards and known or suspected relationships between or among learning objectives. Background knowledge may range from that which is certain to that which uncertain and may include assumptions, theories, inferences, suppositions, likelihoods and probabilities. Background knowledge may include data and information relating to constitutional, statutory, regulatory, judicial or other legal rules, limitations, constraints or guidelines. In some embodiments, the computer systems has the capability of at least one of receiving background knowledge that includes rules, limitations, constraints or guidelines imposed, proposed, issued, adopted, or promulgated by private parties or governmental entities and receiving background knowledge relating to one or more learners or teachers, including entire populations. Items of background knowledge can also include personal attributes of at least one person and tool characteristics or attributes of at least one tool.

In some embodiments, the computer system has a capability of receiving data input directly or indirectly from learner information systems or teacher information systems (e.g., an employee information system).

The computer system will be used to receive the data being input. The computer system will be used to store the data being input. The computer system will be used to retrieve the data being input.

The computer system will be used to manipulate, analyze and/or process the entered data in order to determine which combination of learners, teachers, other interested parties and tools can better or best be used to acquire, learn, teach or impart knowledge, data, information and skills, to make comparisons among learners, teachers, other interested parties and tools, and to make judgments and determinations based on those comparisons. In some embodiments, the computer system has at least one of the following capabilities: data sorting, data rearranging, data reorganizing, data manipulation, data mining, data warehousing, data “slicing and dicing,” dynamic system modeling, emulation and implementation, simulation of teaching and learning activities, dynamic field (including one or more dynamic neural fields) modeling, emulation and implementation, Bayesian logic modeling, emulation and implementation, Bayesian statistical modeling, emulation and implementation, curve fitting, neural net and connectionist modeling, fuzzy-neural system emulation and implementation, classical logic and fuzzy logic techniques, regression (e.g., linear, mulilinear and nonlinear) and other statistical analyses and inferences, and other heuristic methods and approaches. The computer system, in some embodiments, has a capability of one or more of facilitating, enabling, performing, making comparisons, making determinations and marking selections relating to, or making inferences about one or more of the following:
1. What a learner might have acquired, learned, instructed, trained, taught or imparted.
2. What a teacher might have acquired, learned, instructed, trained, taught or imparted.
3. From whom and/or from what tool(s) a learner might acquire or learn or might better or best acquire or learn.
4. To whom and/or with what tool(s) a teacher might instruct, train, teach, or impart or might better or best instruct, train, teach, or impart.
5. How a learner might acquire or learn or might better or best acquire or learn.
6. How a teacher might instruct, train, teach or impart or might better or best instruct, train, teach or impart.
7. How a tool(s) might acquire or learn or might better or best acquire or learn.
8. How a tool(s) better or best instructs, trains, teaches or imparts.
9. How a tool(s) might be used to instruct, train, teach or impart or might better or best be used to instruct, train, teach or impart.
10. What types and/or categories of knowledge, data, information, and/or skills a learner might acquire or learn or might better or best acquire or learn.
11. What types and/or categories of knowledge, data, information, and/or skills a teacher might instruct, train, teach or impart or might better or best instruct, train, teach or impart.
12. What tool(s) might facilitate, enable, assist or aid a learner to acquire or learn or might better or best facilitate, enable, assist or aid a learner to acquire or learn.
13. What tool(s) might facilitate, enable, assist, or aid a teacher to instruct, train, teach or impart or might better or best facilitate, enable, assist, or aid a teacher to instruct, train, teach or impart.
14. What types and/or categories of knowledge, data, information, and/or skills a learner might acquire or learn or might better or best acquire or learn.
15. What types and/or categories of knowledge, data, information, and/or skills a teacher might instruct, train, teach or impart or might better or best instruct, train, teach or impart.
16. What tool(s) might facilitate, enable, assist or aid groups of two or more learners to acquire or learn or might better or best facilitate, enable, assist or aid groups of two or more learners to acquire or learn.
17. What teacher(s) might facilitate, enable, assist or aid groups of two or more learners to acquire or learn or might better or best facilitate, enable, assist or aid groups of two or more learners to acquire or learn.
18. What tool(s) might facilitate, enable, assist, or aid groups of two or more teachers to instruct, train, teach or impart or might better or best facilitate, enable, assist, or aid groups of two or more teachers to instruct, train, teach or impart.
19. What grouping(s) of learner(s), teacher(s) and/or tool(s) might facilitate, enable, assist or aid learner(s) to acquire or learn or might better or best facilitate, enable, assist or aid learner(s) to acquire or learn.
20. What grouping(s) of learner(s), teacher(s) and/or tool(s) might facilitate, enable, assist or aid teacher(s) to instruct, train, teach or impart or might better or best facilitate, enable, assist or aid teacher(s) to instruct, train, teach or impart.
21. What tool(s) might motivate learner(s) to acquire or learn or might better or best motivate learner(s) to acquire or learn.
22. What tools(s) might motivate teachers(s) to instruct, train or teach and might better or best motivate teachers(s) to instruct, train, teach or impart.
23. What tactics or strategies might facilitate, enable, assist or aid acquiring, learning, instructing, training, teaching or imparting or might better or best facilitate, enable, assist or aid acquiring, learning, instructing, training, teaching or imparting.
24. What mappings or interrelationships between and among learner(s), teacher(s) and tool(s) might facilitate, enable, assist, or aid acquiring, learning, instructing, training, teaching or imparting and might better or best facilitate, enable, assist, or aid acquiring, learning, instructing, training, teaching or imparting.

In some embodiments, the computer system has at least one of the following capabilities:
1. Using confidence intervals.
2. Using factorization (as from statistical factor analysis; e.g., regression analysis).
3. Using Gaussian or other gradient weighting applied over arrays of possibilities or other initial, intermediate or output data.
4. Using flowcharts, state descriptions of trained neural nets or dynamic systems (including dynamic neural systems), or other complex patterns of determinations or inferences (possibly interrelated).
5. Using hierarchical rankings (e.g., suggestion that music lessons be tried before fencing lessons without requiring certainty).
6. Using one or more dimensional variable/feature spaces with determinations and/or inferences plotted therein (e.g., matrices or databases).
7. Using combinations of the above (a feature space might have exactly plotted points or 3-D or x-D probabilistic Gaussian “clouds”) (possibly limiting x to tens, hundreds, thousands, ten thousands, hundred thousands, and millions).
8. Using other analytical techniques and approaches employed by the human brain.
9. Using other kinds of outputs/methods of analysis appropriate to complex, multi-dimensional interrelated sets of data and/or information and analyses and/or manipulations thereof.

In some embodiments, the computer system has a capability of implementing a dynamic field with two or more dimensions. In some embodiments, dimensions could number in the tens, hundreds, thousands, ten thousands, one hundred thousands, millions or more. In some embodiments, dimensions could be weighted, distorted, ranked, prioritized, or otherwise manipulated. In some embodiments, the data in one field can be connected to the data in a second field on a one-to-one basis. Alternatively, the data in the one field can be convoluted before it is mapped to the data in the second field.

In some embodiments, the computer system has a capability of at least one of weighing, distorting, ranking, prioritizing, mapping, relating and interrelating and of making at least one determination about at least one weighing, distortion, ranking, prioritization, mapping, relationship or interrelationship among learner(s), teacher(s) and tool(s) and of comparing and selecting based on at least one dimension or factor. In some embodiments, the computer system has a capability of at least one of weighing, distorting, ranking, prioritizing, mapping, relating and interrelating on a deterministic, probabilistic, fuzzy, inferential or other basis. In some embodiments, the computer system has a capability of at least one of analyzing, determining, comparing, selecting, collecting, storing, using and outputting synergies and antagonisms.

In some embodiments, the computer system has a capability of aggregating knowledge, data, information, and skills across learner(s), teacher(s), other interested party(ies) and tool(s) to acquire or learn additional knowledge, data, information, and skills, including:
1. Best and/or better practices
2. Correlations
3. Causes
4. Effects
5. Norms
6. Comparisons
7. Rules of thumb
8. Assumptions
9. Other knowledge, data, information or skills

In some embodiments, the computer system has at least one capability of processing with at least one feedback loop, e.g., the computer system has the capability of (i) employing at least one strategy to aid in at least one selection or ranking of at least one tool, (ii) after the tool is used, collecting at least one data item about the results of the tool's use, (iii) using the data item to refine the computer system or the strategy, and (iv) employing the refined computer system or the strategy to aid in at least one future selection or ranking of the tool. The time duration of the feedback loop can range from course to course, to classroom experience to classroom experience, to test to test, to, in the case of a computer adaptive test, question to question.

In some embodiments, the computer has at least one capability embodied in at least one software product that is commonly referred to as word processing software (e.g., Word 2007®), spreadsheet software (e.g., Excel 2007®), database software (e.g., Access 2007®), presentation software (e.g., PowerPoint 2007®), or email software (e.g., Outlook 2007®).

In some embodiments the computer system has the capability of outputting at least one of one or more printed items, electrical or mechanical indicators (e.g., lights, gauges), one or more electronic documents (e.g., text, XML), one or more electronic files (e.g., a document, a dataset), one or more audio outputs, one or more video outputs, one or more diagrams, one or more charts, one or more animated demonstrations, one or more electronic presentations, one or more tools, and one or more other forms of output.

The computer system, in some embodiments, has a capability of at least one of preparing may and outputting data and information in human readable form or in a form readable by one or more items of software or hardware. The computer system, in some embodiments, has a capability of at least one of preparing and outputting data and information that can be used to formulate one or more tests, one or more test questions, one or more study aids, one or more tools, one or more teacher aids and one or more tools.

The computer system, in some embodiments, has a capability of providing privacy protection to one or more learner, one or more teachers and one or more other interested parties by allowing at least one learner, teacher or other interested person to enter or supply some or all data or information about himself or herself or others on an anonymous or pseudonymous basis. In some embodiments, the computer system has a capability of allowing actual data or information to be entered or supplied on an anonymous or pseudonymous basis such that they could be made available only to the supplier or only to the supplier and others who have permission from the supplier to access some or all of the data or information supplied on a pseudonymous or anonymous basis. The computer system, in some embodiments, has a capability of aggregating data and information supplied on a pseudonymous or anonymous basis with other data and outputting the resulting aggregation to others, possibly depending on the permissions given by the data supplier(s) or others. The computer system, in some of embodiments, has a capability of using data and information supplied on a pseudonymous or anonymous basis to make calculations or perform analyses and outputting results to learners, teachers or other interested parties without disclosing the data or information supplied pseudonymously or anonymously. Data or information supplied on a pseudonymous or anonymous could constitute a trade secret, and, in some embodiments, the computer system has a capability of according trade secrets additional protection.

The computer system, in some embodiments, has a capability of at least one of providing security and using security techniques, including encrypting, authenticating, applying “need to know” protocols, disaggregating, and distributing of data or information across multiple locations.

The computer system, in some embodiments, has a capability of allowing or requiring at least one of data input, data storage, data retrieval, data processing, or data output to conform to a structure, standard, protocol, framework or taxonomy, which structure, standard, protocol, framework or taxonomy may either be fully proprietary, open source or in the public domain and into which at least one of one or more identities, one or more traits, one or more characteristics, one or more statuses, one or more skills, one or more motivations, one or more styles, one or more histories, one or more records, one or more activities, one or more methods, one or more methodologies, one or more tools, one or more mappings, one or more relationships, one or more interrelationships, and one or more items of background knowledge may be mapped. Once data is mapped to a structure, standard, protocol, framework or taxonomy, the computer system, in some embodiments, has a capability of using the mapped, related or interrelated data to conduct the computer system's calculations, perform the computer system's analysis, and prepare and deliver the computer system's output. In some embodiments, the computer system has a capability of using the same or a different a structure, standard, protocol, framework or taxonomy to communicate with teachers, learners, other interested persons, other individuals, software and hardware.

In some embodiments, the computer system, using at least one of the computer system's items of data, at least one of the computer system's items of information, at least one of the computer system's calculations, at least one of the computer system's analyses and at least one of the computer system's items of output, has the capability of at least one of producing written work product that provides summative and formative results, producing billing written work product, producing pricing and bidding written work product, producing written work product that responds to RFPs and RFQs, producing advertising and marketing written work product, producing sales written work product, preparing one or more tools (e.g., scholarly articles or books, trade articles or books, textbooks, teaching or learning aids), preparing written work product relating to one or more tools, conducting research, preparing research written work product, and producing written work product in connection with raising debt or equity capital (including from friends, family, “angel” investors, venture capitalists, private equity investors, institutional investors, private offerings, or public offerings) and providing written work product supporting any of the foregoing.

In some embodiments, the computer system has a capability of at least one of making calculations, analyzing at least one item of knowledge, data and information acquired by the computer system, and using its output to compute and output prices, which prices may be computed on a per learner basis, a per teacher basis, a per enterprise basis, a per machine basis, a per concurrent user basis (whether learner or teacher), a per seat basis, a per use basis (possibly with pricing based on the nature of each use), or a flat fee basis. In some embodiments, the computer system has a capability of at least one of computing and outputting prices based in full or in part on performance of the computer system, the computer system's calculations, the computer system's analysis, the computer system's knowledge, data and information, or the computer system's output, and, in some embodiments of measuring absolute or relative performance of one or more learners, one or more teachers or one or more tools, measuring growth or improvement in performance of one or more learners, one or more teachers or one or more tools or using at least one other performance measuring approach. In some embodiments, the computer system has a capability of at least one of making its calculations, conducting its analysis, imparting its knowledge, data and information, or providing output on a perpetual license basis, on a term license basis and on a “software as a service” basis. The computer system, in some embodiments, has a capability of using at least one of the computer system's items of data, the computer system's items of information, the computer system's calculations, the computer system's analysis and the computer system's items of output to produce invoices, statements or bills.

The computer system, in some embodiments, has a capability of using the computer system's calculations, the computer system's analysis, the computer system's knowledge, the computer system's data and the computer system's information, or the computer system's output to compute charges for maintenance and support (e.g., bug fixes, software modifications, updates, upgrades, “help-desk” support), whether such maintenance and support or charge is recurring or not and to issue bills, invoices or statements for such maintenance and support.

The computer system, in some embodiments, has a capability of using the computer system's calculations, the computer system's analysis, the computer system's knowledge, the computer system's data and the computer system's information, or the computer system's output to compute charges for custom modifications or improvements, data conversions or installation services relating to the computer system, the computer system's calculations, the computer system's analysis, the computer system's knowledge, the computer system's data and the computer system's information, or the computer system's output, and to provide written work product related thereto.

The computer system, in some embodiments, has a capability of using the computer system's calculations, the computer system's analysis, the computer system's knowledge, the computer system's data and the computer system's information, or the computer system's output to prepare one or more agreements with a user of the computer system, the computer system's calculations, the computer system's analysis, the computer system's knowledge, the computer system's data and the computer system's information, or the computer system's output. In some embodiments, such an agreement may contain provisions that describe what is being contracted for, that describe the manner in which the computer system, the computer system's analysis, the computer system's knowledge, the computer system's data and the computer system's information, or the computer system's output may be used, that require the user to keep software, trade secrets, or proprietary data or information confidential, that relate to ownership of intellectual property, that relate to breach, termination, and dispute resolution, that relate to payment and collection, that relate to warranties and indemnification, and that relate to the allocation of one or more risks.

In one embodiment, a teacher who is preparing a lesson on fractions for a class of thirty learners would input data about (i) the teacher's own skills and the teacher's own teaching style, (ii) the 30 learners' various traits and motivations, (iii) a list and description of three tools that are available, and iv) background knowledge relating to past results of the three tools and the skills, styles, traits and motivations of those who used each, Using regression analysis, the computer system would process the data entered by the teacher and would output at least one prediction about which of the three tools would be most likely to best teach each learner, including a possible prediction that that different learners might best learn using different tools. The teacher would then use the tool that is best for each learner. The thirty learners would then be tested on fractions, and the test results would then entered into the computer system, either to support future regression analyses for the same students or to provide additional background knowledge.

In another embodiment, a dynamic field could be created with two dimensions:

1. A problem to be solved (plotted on a continuum, where for example, fractions are plotted close to decimals but far from integrals); and

2. Two approaches used to teach learners (e.g., auditory versus visual-based lessons).

This input field (along with at least one supporting field) would receive Gaussian input that simulates past or current instructional experience along the two dimensions. Successful performance at test could cause corresponding growth at the same positions along these two axes in a memory field, while unsuccessful performance could cause corresponding accelerated decay in the memory field. At least one known factor (including, for example, a bias) of a learner would be represented by an uneven resting level of the input field. The two approaches would be modeled, and the most successful alternatives would be outputted for usage in a classroom. Success or failure at test would then allow the memory field to be updated. Such a model could also be used without any biases, learning styles, etc. and then its results could be compared to a learner's actual results to determine that learner's biases, learning styles, etc.

In another embodiment, a neural net would be created for the situation described in paragraph XXX above. It would have an input layer, an output layer, and optionally at least one intermediate layer. The input layer would include at least node and would be capable of receiving input data described in (i) and (ii) in paragraph 0040 above. The output layer would include at least one node would be capable of depicting the three tools described in (iii) above. The neural net would be then be trained using the data described in (iv) above. After the neural net is trained, the data described in (i) and (ii) would be input, and the neural net would be used to select the best tool for each of the thirty learners.

Note that embodiments herein can include a memory storing executable instructions that, when executed, cause a computer system to carry out one or more of the operations discussed herein. There can be a machine adapted to do any of the operations herein, as well as a method of making the machine and a method of using the machine. Articles of manufacture are also provided, on their own and as products produced by a process herein.

In sum, appreciation is requested for the robust range of possibilities flowing from the core teaching herein. More broadly, however, the terms and expressions which have been employed herein are used as terms of teaching and not of limitation, and there is no intention, in the use of such terms and expressions, of excluding equivalents of the features shown and described, or portions thereof, it being recognized that various modifications are possible within the scope of the embodiments contemplated and suggested herein. Further, various embodiments are as described and suggested herein. Although the disclosure herein has been described with reference to specific embodiments, the disclosures are intended to be illustrative and are not intended to be limiting. Various modifications and applications may occur to those skilled in the art without departing from the true spirit and scope defined in the appended claims.

Thus, although only a few exemplary embodiments have been described in detail above, those skilled in the art will readily appreciate from the foregoing that many modifications are possible in the exemplary embodiments without materially departing from the novel teachings and advantages herein. Accordingly, all such modifications are intended to be included within the scope defined by one or more claims. In the claims, means-plus-function claims are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment fastening wooden parts, a nail and a screw may be equivalent structures.

1. An apparatus, comprising: a computer system, including a processor to receive at least one first content item in which at least one first content item ownership person has an ownership interest, at least one second content item in which at least one second content item ownership person has an ownership interest, at least one first content item rule for at least one of access to or use of the first content item and at least one second content item rule for at least one of access to or use of the second content item, and to process at least one query based at least in part on the first content item and the second content item and the first content item rule and the second content item rule, and to retrieve at least one result of the query, a storage medium to store the first content item and the second content item and the first content item rule and the second content item rule and the query and the result, and an output device to report the query and the result, wherein every content item ownership person's access to at least one content item is limited by at least one content item rule that is imposed by a person other than such content item ownership person.

2. The apparatus of claim 1, wherein at least one of the first content item rule and the second content item rule is used to increase the privacy or security of data or a data subject.

3. The apparatus of claim 1, wherein a first person who imposes the first content item rule and a second person who imposes the second content item rule agree to give each other access to the computer system based on reciprocity.

4. The apparatus of claim 1, wherein at least one verifier provides at least one verification of at least one of the first content item and the second content item.

5. The apparatus of claim 4, wherein the validity of the verification can be determined from the result without any other access to the first content item or the second content item.

6. The apparatus of claim 1, wherein a data subject has access to at least one content item that relates to the data subject.

7. The apparatus of claim 6, wherein a data subject has access to at least one access to at least one content item that relates to the data subject.

8. The apparatus of claim 6, wherein a data subject has access to at least one use of at least one content item that relates to the data subject.

9. The apparatus of claim 1, wherein at least one content item refers at least one of a trait, skill, motivation and style of a learner, a teacher or an other interested person, and wherein the query and the result relate to acquiring, learning, teaching or imparting of knowledge, data, information, or skills by or for the teacher or the learner.

10. The apparatus of claim 1, wherein the first content item includes a personal attribute of a learner, a teacher or an other interested person and the identity of the learner, the teacher or the other interested person.

11. The apparatus of claim 10, wherein the second content item includes a tool attribute of a tool and the identity of the tool.

12. The apparatus of claim 10, wherein the second content item includes background information.

13. An apparatus, comprising: a computer system, including a processor to receive at least one content item, and to process at least one query based at least in part on the content item, and to retrieve at least one result of the query, a storage medium to store the content item and the result, and an output device to report the result, wherein the content item refers at least one of a trait, a skill, a motivation and a style of a learner, a teacher or an other interested person, and wherein the query and the result relate to acquiring, learning, teaching or imparting knowledge, data, information, and skills by or for the teacher or the learner.

14. The apparatus of claim 13, wherein at least two content items refer at least two of the trait, the skill, the motivation and the style of the learner, the teacher or the other interested person.

15. The apparatus of claim 13, wherein at least three content items refer at least three of the trait, the skill, the motivation and the style of the learner, the teacher or the other interested person.

16. The apparatus of claim 13, wherein at least four content items refer at least four of the trait, the skill, the motivation and the style of the learner, the teacher or the other interested person.

17. The apparatus of claim 13, wherein at least one second content item is background information.

18. The apparatus of claim 13, wherein the content item is incorporated into a framework.

19. The apparatus of claim 13, wherein the processor can receive at least one second content item and can process at least one mapping or relationship or interrelationship among the content item and the second content item.

20. The apparatus of claim 13, wherein the processor can receive at least one second content item and can process at least a second mapping or relationship or interrelationship among the content item and the mapping or the relationship or the interrelationship.

21. The apparatus of claims 18 and 19 and 20, wherein the content item, the second content item and the mapping or the relationship or the interrelationship are incorporated into the framework.

22. The apparatus of claim 13, wherein the result includes at least one summative or formative result.

23. The apparatus of claim 13, wherein the result includes at least one of a bill, a statement, and an invoice.

24. The apparatus of claim 13, wherein the result includes support for at least one of a bill, a statement, and an invoice.

25. The apparatus of claim 13, wherein the result includes at least one of a quote, a price, a bid, a proposal, a response to an RFP, or a response to an RFQ.

26. The apparatus of claim 13, wherein the result includes support for at least one of a quote, a price, a bid, a proposal, a response to an RFP, or a response to an RFQ.

27. The apparatus of claim 13, wherein the result includes at least one of a written advertising product, a written marketing product, or a written sales product.

28. The apparatus of claim 13, wherein the result includes support for at least one of a written advertising product, a written marketing product, or a written sales product.

29. The apparatus of claim 13, wherein the result includes at least one tool.

30. The apparatus of claim 13, wherein the result includes at least one support for the selection or ranking of the tool.

31. The apparatus of claim 13, wherein the result includes at least one of a book, a textbook, an article, an essay, an item of software, or a teaching or learning aid.

32. The apparatus of claim 13, wherein the result includes at least one support for at least one of the book, the textbook, the article, the essay, the item of software, or the teaching or learning aid.

33. The apparatus of claim 13, wherein the result includes at least one written work product to raise debt or equity capital.

34. The apparatus of claim 13, wherein the result includes at least one support for the written work product to raise debt or equity capital.

35. The apparatus of claim 13, wherein the result includes at least one of a contract or agreement with a learner, a teacher, an other interested person, or another person.

36. The apparatus of claim 13, wherein the result includes at least one support for the contract or agreement with the learner, the teacher, the other interested person, or the another person.

37. The apparatus of claim 13, wherein the result includes a determination of at least one price.

38. The apparatus of claim 37, wherein the price is determined at least in part on meeting in full or in part at least one performance requirement.

39. A method of using an apparatus comprising a computer system, the method including:
receiving, at a processor of a computer system, at least one first content item in which at least one first content item ownership person has an ownership interest, at least one second content item in which at least one second content item ownership person has an ownership interest, at least one first content item rule for at least one of access to or use of the first content item and at least one second content item rule for at least one of access to or use of the second content item;
processing, by the computer system, at least one query based at least in part on the first content item and the second content item and the first content item rule and the second content item rule;
receiving, by the computer system, at least one result of the query;
storing, by the computer system, in a storage medium, the first content item and the second content item and the first content item rule and the second content item rule and the query and the result; and
outputting, at an output device of the computer system, a report of the query and the result, wherein every content item ownership person's access to at least one content item is limited by at least one content item rule that is imposed by a person other than such content item ownership person.
